(19) United States
(12) Patent Application Publication
(10) Pub. No.: US 2005/0007967 A1
(43) Pub. Date: Jan. 13, 2005

(54) Co-operative protocol for wireless device interaction with intelligent environments

(76) Inventors: Dhananjay V. Keskar, Beaverton, OR (US); Brad Needham, North Plains, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/616,734

(22) Filed: Jul. 9, 2003

(51) Int. Cl. H04B 7/00

(52) U.S. Cl. 370/310; 340/825.5; 370/338

(57) ABSTRACT

A method, machine readable medium, and system is disclosed. In one embodiment the method comprises establishing a connection between a wireless electronic device and one or more supervisory devices associated with a local area of wireless coverage, negotiating an associated environment protocol between the wireless device and the one or more local area supervisory devices, and determining which functions are available for use on the wireless device in the local area based on the outcome of the negotiation.

### BACKGROUND

Wireless devices, such as mobile phones and personal digital assistants, are becoming increasingly common and ubiquitous with people relying on being connected and accessible. At the same time, there exist environments which require restricting the use of wireless transmissions. For example, in social environments such as concerts, theatres, etc. users are expected to switch their devices to ‘silent’ mode. At the same time, users are required to switch off their wireless devices while in hospitals, airplanes, etc. Inadvertent or intentional non-compliance by users may result in irritation, errors, and even potential life and death situations.

Compounding the problem is the fact that certain modes in combination devices (E.g. personal digital assistant (PDA)/cellular phone combination devices) could be permissible in certain locales. A PDA-phone, for instance, could be used during an airline flight to take notes or play a game but not as a phone. This creates a problem for the owner of the phone and the airline. Even if the PDA-phone was able to turn off its cellular capabilities and just operate in a non-wireless mode on the airplane there is no reliably guaranteed way for authorities to ensure that the device is being operated only in the permissible mode. As a result, to preempt liability issues, authorities may insist on all wireless-capable devices to be completely switched off, thus negating the benefit of carrying such combination devices.

Furthermore, a user could have a wireless device that has operational modes such as silent, vibrate, ring, wireless-mode off, and device off, to name a few. Every one of these modes can be useful for the user operation of the device under certain circumstances and in certain environments. Currently, the user has to take the device out of his pocket and manually switch the mode when he switches environments, which can be burdensome to anyone. Occasionally the user actually forgets to switch the mode to the appropriate setting to the frustration of all nearby (i.e. a phone goes off in a movie theater). The more active and mobile the user is the greater a burden the manual switching of modes becomes. For example, a person moving from a classroom to a busy street to an airplane would require three different operational modes.

Thus, there is a need for an effective protocol and mechanism that allows local area environments to convey wireless usage preferences and restrictions to mobile devices. Such devices can then use this information to adjust their permissible usage. This adjustment on behalf of the device could be optional and subject to the desires and preferences of the user. Alternatively this adjustment could be made mandatory based on legal and/or regulatory requirements and supported by mobile device manufacturers.

### BRIEF DESCRIPTION OF THE DRAWINGS

The present invention is illustrated by way of example and is not limited by the figures of the accompanying drawings, in which like references indicate similar elements, and in which:

FIG. 1 illustrates an embodiment of the environment in which the present invention operates.

FIG. 2 illustrates an embodiment of the wireless device's routine to search for local area supervisory devices.

FIG. 3 illustrates an embodiment of the process used to determine the wireless device's usage profile while in a local area populated by one or more supervisory devices.

FIG. 4 illustrates a step-by-step process to determine whether a particular wireless device activity or function is allowed in a given environment in one embodiment of the invention.

FIG. 5 illustrates a comparison between a wireless device's capabilities and user preferences and a set of local area preferences and user restrictions, in three separate example locations, in one embodiment of the invention.

FIG. 6 illustrates a detailed list of local area preferences per location for receiving a cellular phone call in one embodiment of the invention.

FIG. 7 illustrates an environment that includes multiple local hubs in the vicinity of the wireless device in one embodiment of the invention.

### DETAILED DESCRIPTION

A method for determining the mode of operation of a wireless device in a given environment by comparing local environment usage preferences and restrictions with wireless device capabilities and user preferences is described. In some instances, well-known elements, protocols, and file types such 802.11, Bluetooth, CDMA, and MP3s have not been discussed in special detail in order to avoid obscuring the present invention.

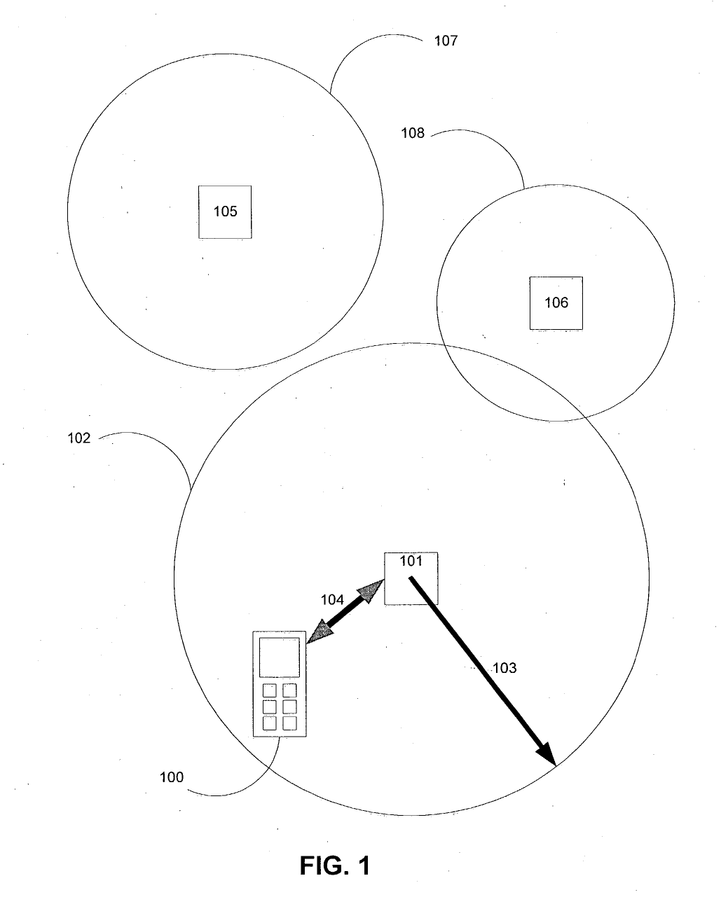

FIG. 1 illustrates one embodiment of the environment in which the present invention operates. Wireless device 100 enters a location where local area supervisory device 101 operates. Local area supervisory device 101 sends out a local ping notifying any wireless devices in the area of its presence. The local ping is subject to a certain sphere of influence 102 with a given radius 103, beyond which the wireless device 100 does not receive the ping. When wireless device 100 does enter into the local area supervisory device's 101 sphere of influence 102 the two devices will establish a communication link 104 with each other. Other local area supervisory devices such as 105 and 106 can be located in the vicinity with their respective spheres of influence 107 and 108. In another embodiment of the invention the wireless device 100 could be the device that sends out a ping and the local area supervisory devices 101, 105, and 106 could be the ones receiving the ping. In any event, once a communication link has been established it is irrelevant which device initially sent out the ping and which device initially received the ping.

Each local area supervisory device shown in FIG. 1 can consist of a variety of devices. At a minimum, a local area supervisory device must be able to accomplish three functions. Initially, the local area supervisory device must either send out a ping to indicate its presence or search for and receive a ping from any wireless devices in the local environment. Next, the local area supervisory device must be able to send and receive communication streams with wireless devices in the local environment. Finally, the local area supervisory device must be capable of storing the local area preferences and restrictions used to compare with the wireless device capabilities and user preferences to determine the mode of operation for any wireless device in the local environment. In one embodiment of the invention each of these functions could be assigned to individual devices. In another embodiment of the invention all local area supervisory device functions could be incorporated into one universal device, as FIG. 1 illustrates. Additionally, the local area supervisory device can also perform other added functions as necessary such as operating as a local communication hub to the Internet among many others.

The wireless device 100 can simultaneously be within the spheres of influence of multiple local area supervisory devices. In an embodiment where spheres of influence overlap each other it would be imperative that the wireless device distinguish the two or more local area supervisory devices and their individual local area preferences and restrictions. Thus, in one embodiment of the invention each local area supervisory device within a given area incorporates a unique ping, such as a unique frequency, that is different than the other local area supervisory devices, which can be used for differentiating the devices. In another embodiment of the invention, the wireless device can differentiate between each local area supervisory device using the time interval between each ping, or by analyzing the received signal strength. It is also possible to use device location information (at suitable resolution and precision) to decide the local supervisory device applicable to the device. In yet another embodiment of the invention any local area supervisory devices that have overlapping spheres of influence can coordinate with each other, based on priority and security levels of their respective restrictions and preferences, and come up with a uniform set of local area preferences and restrictions that they all broadcast.

Although the environment in FIG. 1 is only a two dimensional diagram, it is inherent that a sphere of influence is a three dimensional volume. Thus, it is entirely possible that a wireless device is located in the same X and Y coordinates on a map as a local area supervisory device but not within that device's sphere of influence. For example, this can be the case when the two devices are on different floors of a tall building or when one device is in an airplane and the other is on the ground.

The wireless device in FIG. 1 is comprised of at least a processing unit and a wireless communication input/output interface. Additionally, the wireless device can incorporate a multitude of circuits or functional units to increase the functionality of the device. These functional units can include, but are not limited to, a wireless device capabilities and user preferences aggregator, an interpreter used to interpret local area preferences and restrictions, a multi-mode wireless communication interface to utilize many different available local area wireless protocols, a listening device to detect local area supervisory device pings, a control unit for wireless device usage profiles, a global position system unit, a mass storage device, and a multimedia graphical display unit among many others.

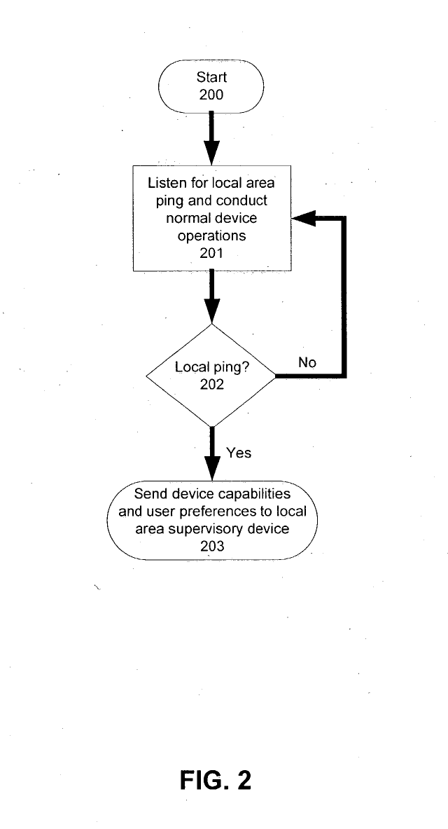

FIG. 2 illustrates an embodiment of the wireless device's routine to search for local area supervisory devices. Upon the start 200 of this search routine the wireless device will continuously listen for the local area ping of a supervisory device while allowing for normal device operations 201. The wireless device polls whether or not it has received a local ping 202. If the wireless device has not received a ping it continues in its listening mode while conducting normal device operations 201. Once the wireless device does receive a ping from a local area supervisory device it sends the local area supervisory device its device capabilities and user preferences 203. The device capabilities can include, but are not limited to, compatible data transmission and communication protocols, video and audio capabilities, associated application programs which the device is capable of using, information associated with any connected peripherals, among others.

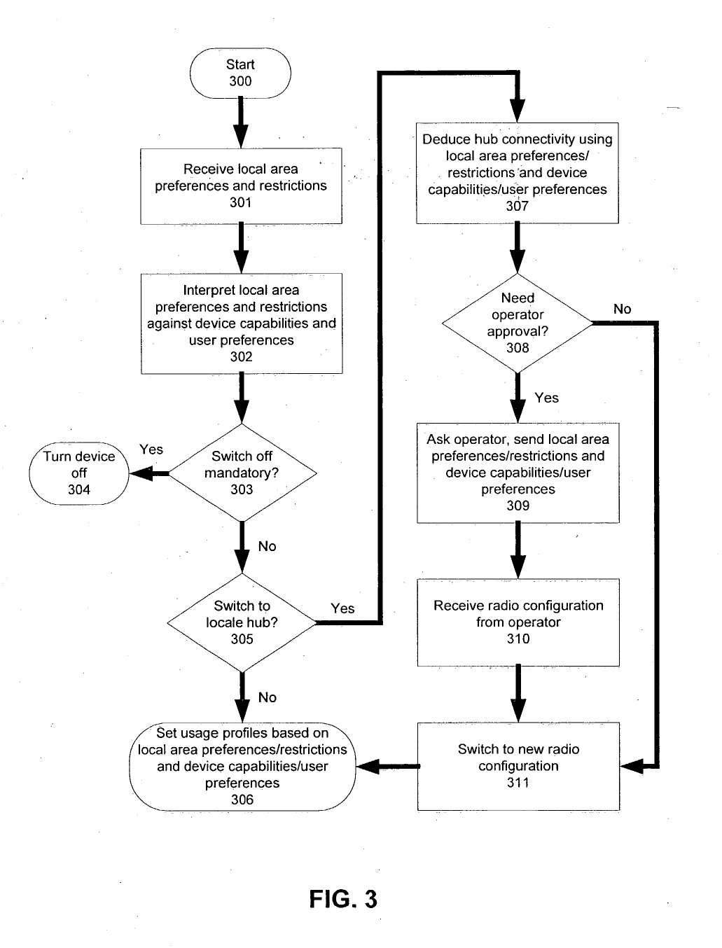

FIG. 3 illustrates an embodiment of the process used to determine the wireless device's usage profile while in a local area populated by one or more supervisory devices. In one embodiment, this decision making process will be contained on the wireless device. In other embodiments of this invention locations where this process can take place include, but are not limited to, the local area supervisory device or an independent device apart from the aforementioned supervisory device and wireless device. In one embodiment of the invention, the process detailed in FIG. 3 will take place subsequent to the process detailed in FIG. 2. At the start 300 of the process the local area preferences and restrictions are received from the supervisory device 301. Then the local area preferences and restrictions are interpreted and compared against the capabilities and user preferences of the wireless device 302. Upon completion of the comparison it is determined whether or not the wireless device will need to be immediately turned off 303. If so, the device is turned off 304. Otherwise, a second determination is made as to whether a local communication hub exists in the local area of the corresponding supervisory device 305. A local hub may be either mandatory or optional, with the goal of providing wireless connectivity with a minimum of interference in a manner deemed acceptable for the local environment. If a compatible local hub does not exist then the usage profile of the wireless device is set based on the interpretation (made in box 302) of a comparison of the local area preferences and restrictions against the wireless device capabilities and user preferences 306. Otherwise, upon deciding to switch to the local hub, the connectivity between the wireless device and the local hub must be determined for establishing the communication link 307. Once the protocol for the communication link is established it must be determined whether operator approval is needed to reconfigure the wireless device for local hub compatibility 308. If operator approval is not needed, the wireless device will switch to the new configuration automatically to establish a communication link with the local hub 311. Then the usage profile of the wireless device will be set based on the interpretation (made in box 302) of a comparison of the local area preferences and restrictions against the wireless device capabilities and user preferences 306. Otherwise, where operator approval is required in box 308, the operator is asked whether to switch to the new configuration by being provided choices based on the interpreted local area preferences/restrictions and the wireless device capabilities and user preferences 309. The operator then responds by selecting his preferred communication configuration 310 and the wireless device switches to the preferred configuration 311. Finally, the usage profile of the wireless device is set based on the interpretation (made in box 302) of a comparison of the local area preferences and restrictions against the wireless device capabilities and user preferences 306.

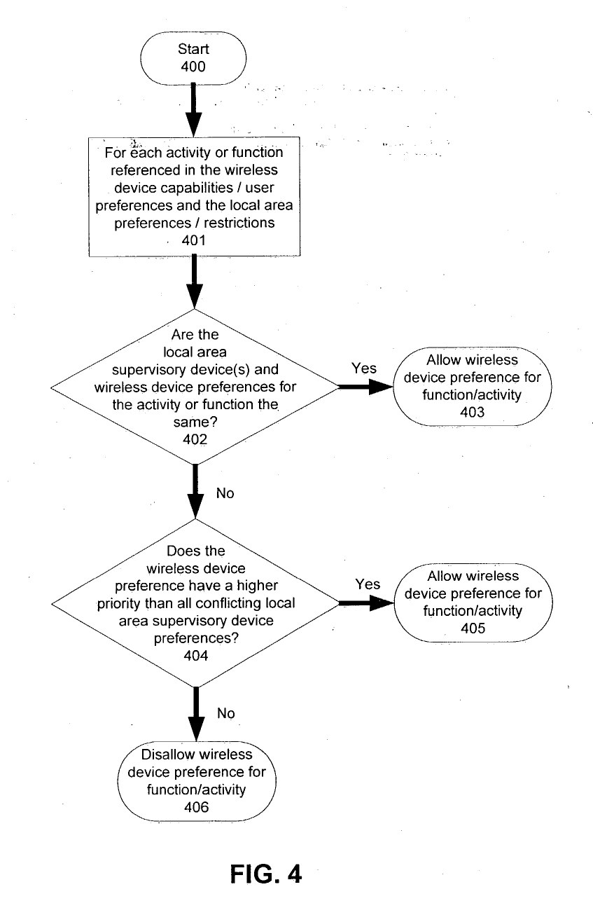

FIG. 4 illustrates a step-by-step process to determine whether a particular wireless device activity or function is allowed in a given environment in one embodiment of the invention. A preference priority system allows for prompt decision making during the interpretation process (FIG. 3, box 302) where a comparison is made between the local area preferences/restrictions and the wireless device capabilities/user preferences. The process systematically goes through every function and activity that both the wireless device and the local area supervisory device understand 401. Examples of functions include cellular telephony, global positioning systems, personal digital assistant utilities, MP3 playback, radio functionality, and video playback among others. Examples of activities include receiving an incoming phone call, using a word processor feature, and playing the radio among others. Examples of preferences for each function/activity include whether to allow or disallow the function/activity as well as preferring one of a variety of possible modes for each function/activity (E.g. whether to have the cellular telephone on ring or vibrate mode). Thus, for each function/activity a comparison is made to determine if both the local area supervisory device preference and the wireless device preference match (box 402). If the preferences match then the wireless device preference for that function/activity is allowed in the local area environment (box 403). If the preferences are dissimilar then a second comparison is made to determine whether the local area supervisory device preference or the wireless device preference has a higher priority for the given function/activity (box 404). If the wireless device priority is higher than all local area supervisory device priorities, then the wireless device preference is allowed in the local area environment (box 405). Otherwise, if any one local area supervisory device priority is the same or higher than the wireless device priority, then that local area supervisory device preference is controlling and the wireless device preference for the given function/activity is not allowed (box 406).

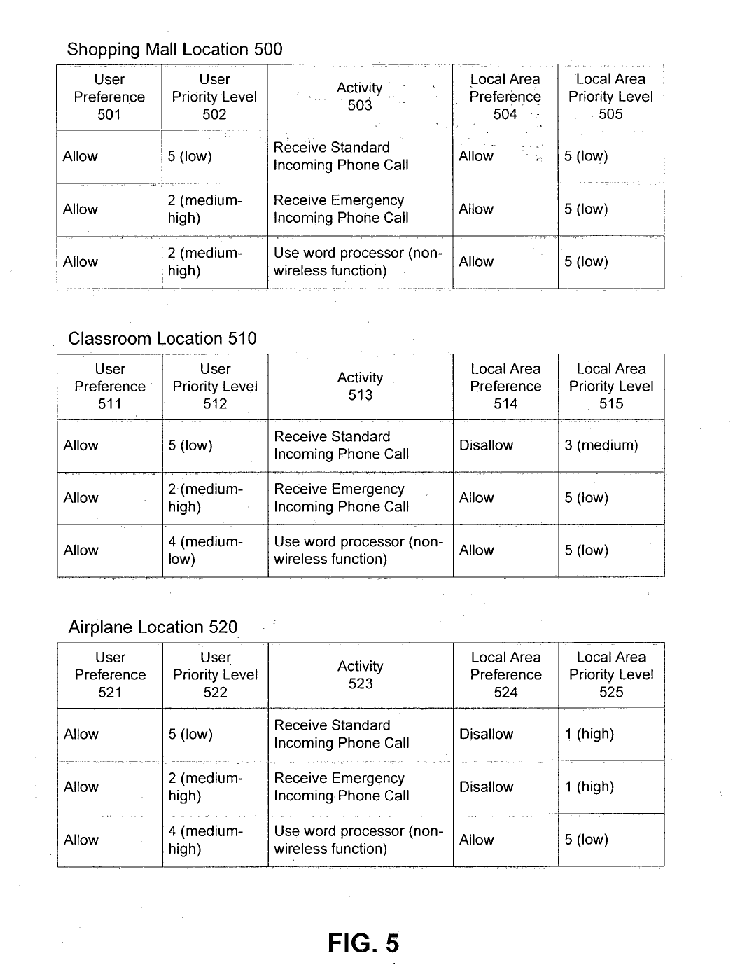

FIG. 5 illustrates a comparison between a wireless device's capabilities and user preferences and a set of local area preferences and user restrictions, in three separate example locations, in one embodiment of the invention. In this example the wireless device has multiple functions including cellular phone and personal digital assistant capabilities. Therefore, the wireless device is capable of performing many activities 503 including receiving a standard incoming phone call, receiving an emergency incoming phone call, and using the word processor included with the device among others. In shopping mall location 500 the user preference 501 is to allow all of these activities to take place. The local area supervisory device also has a preference 504 to allow all of these activities. After comparing the preferences and determining an identical match, a determination is made to allow all user preferences for the wireless device. In certain situations the user might not want to allow certain activities to take place in certain environments. For example, a parent might restrict usage of a child's cellular phone to limited locations. In this scenario a local area supervisory device might allow cellular usage but the wireless device actually disallows its own usage.

In classroom location 510 the same preference comparison is made between the local area supervisory device and the wireless device regarding the activities 513. Again, the user preference is to allow all activities 513 including receiving a standard incoming phone call, receiving an emergency incoming phone call, and using the word processor included with the device among others. On the other hand, the local area supervisory device in this location does not want to allow a standard incoming phone call due to classroom etiquette. In this case the user preference 511 and the local area supervisory device preference 514 are different. When the preferences are dissimilar a second comparison is made to determine which device preference prevails. For each activity 513 there exists a device priority level (512 and 515). For the standard incoming phone call activity the local area supervisory device has a medium priority while the wireless device has a low priority. Thus, the local area supervisory device prevails with the higher priority and the standard incoming phone call activity is disallowed in the classroom location 510.

Another activity preference comparison is made in airplane location 520. The same preference comparison is made between the local area supervisory device and the wireless device regarding the activities 523. Once again, in this environment the user preference is to allow all activities 513 including receiving a standard incoming phone call, receiving an emergency incoming phone call, and using the word processor included with the device among others. In this case though, the use of any cellular phone technology in an airplane that is flying can be potentially dangerous to all passengers aboard. Thus, an airplane does not want to allow any cellular phone to be in use or even powered on. The user preference 521 and the local area supervisory device preference 524 are different for allowing phone calls. The local area supervisory device located in the airplane has a high priority level for its preference to disallow any incoming phone calls 525 while the wireless device has a low priority level for allowing incoming phone calls 522. Therefore, the local area supervisory device prevails with the higher priority and any incoming phone call activity is disallowed in the airplane location 510.

In one embodiment of the invention the local area supervisory device can change its preferences to allow and disallow certain functions or activities in its environment. For example, an airplane that is docked with the gate at an airport terminal could allow cellular telephony and then change its preference, in real time, to prohibit phone calls once the airplane has left the gate. In this scenario the local area supervisory device located on the airplane could broadcast an update signal to all wireless devices within its sphere of influence. Once the signal was broadcast the wireless devices would again go through the step-by-step process detailed in FIG. 3 and FIG. 4 to determine what local area preferences changed and if those affect the functionality of the wireless device.

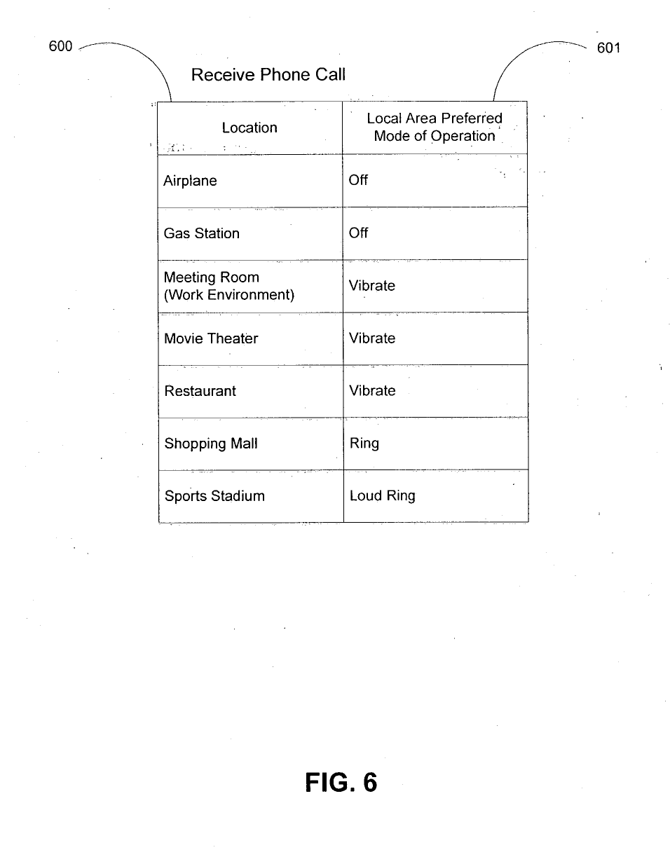

FIG. 6 illustrates a detailed list of local area preferences per location for receiving a cellular phone call in one embodiment of the invention. The list of locations 600 has a corresponding list of local area preferred modes of operation 601. A local area preferred mode of operation consists of the specific preference that a local area supervisory device, which is located in that environment, has regarding the receive phone call activity. In certain environments such as airplanes and gas stations the local area supervisory device would prefer that any cellular phone were to be turned off due to safety regulations. In less hazardous environments such as during a meeting, in a movie theater, and in a restaurant the local area supervisory device would prefer that any cellular phone were in vibrate mode for common courtesy. There are other environments, such as in a shopping mall, where it is acceptable to have the phone ring. Additionally, in extremely noisy environments such as sports stadiums where a standard ring tone would not be heard, the local area supervisory device can set a preference to a loud ring as a courtesy to the user of the wireless device.

Certain wireless environments can take advantage of local communication hubs to increase bandwidth for compatible wireless devices located in the sphere of influence. In addition to the functional determination for wireless device operation in the local area sphere of influence (I.e. whether to turn the device off, whether to turn the device on vibrate mode, etc.), there also exists the potential to switch the protocol for the communication link if another wireless protocol is available in the local area sphere of influence. Thus, if a multi-protocol compatible wireless device, using a slow protocol, enters an environment that offers a superior protocol, the device could switch to the superior protocol. Possible wireless communication protocols would include 802.11a, 802.11b, 802.1 g, Bluetooth, GSM (Global System for Mobile communications), CDMA, and TDMA (Time Division Multiple Access) among others. In one embodiment a local hub uses a communication protocol that is superior to the current protocol that the wireless device is utilizing. Upon discovery of the available superior protocol, the wireless device connects with the local hub and begins to transfer data using the new protocol. In another embodiment the local hub offers multiple communication protocols and the wireless device opts for the best compatible protocol.

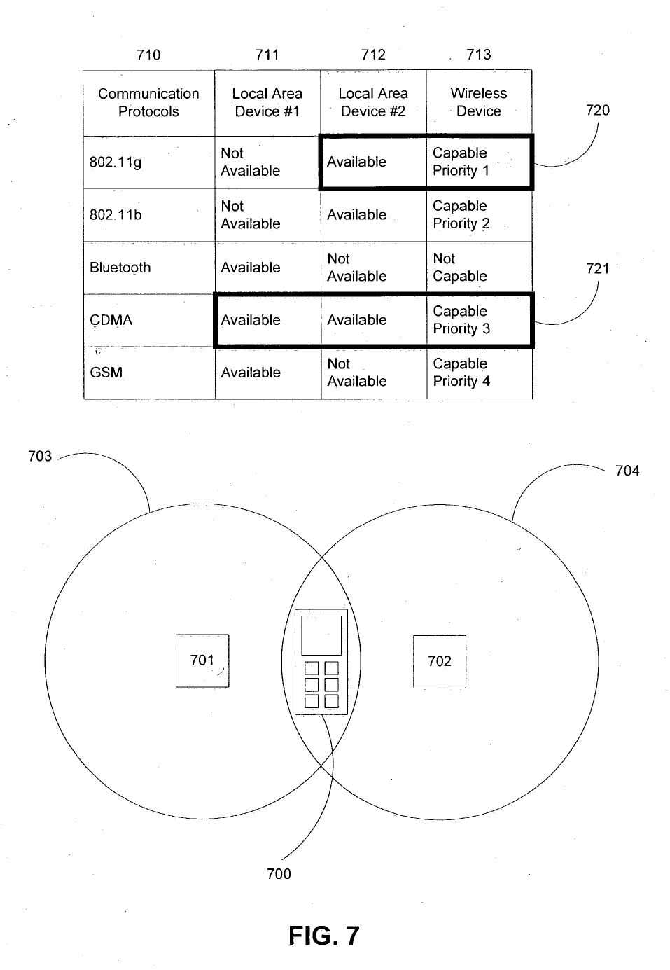

FIG. 7 illustrates an environment that includes multiple local hubs in the vicinity of the wireless device in one embodiment of the invention. The wireless device 700 is in a location where two local area supervisory devices (701 and 702) have overlapping spheres of influence (703 and 704 respectively). Each local area supervisory device has one or more associated local hubs. Thus, multiple communication protocols (column 710) are offered per local area device (columns 711 and 712). Additionally, the wireless device 700 is compatible with more than one protocol (column 713). In one embodiment the wireless device can have a predetermined list of priorities for all compatible protocols (column 713). This predetermined list possibly would be based on the bandwidth capabilities of each protocol. In one embodiment the wireless device's decision making process consists of determining the highest priority communication protocol offered by any local area supervisory device (box 720). In another embodiment the wireless device's decision making process consists of determining the highest priority communication protocol offered by all local area supervisory devices (box 721).

A wireless device that is compatible with multiple protocols must have a way to select which protocol to use. As previously mentioned, in one embodiment the wireless device can have a predetermined priority list of all compatible protocols. This list can be created by the manufacturer of the wireless device, the retail seller of the device, or the end user of the device among others. In another embodiment the wireless device's list can be created, modified, and updated by one or more local area supervisory devices, which download the configuration information to the wireless device. In yet another embodiment there is no predetermined priority list of protocols. As a result, any time a local area supervisory device notifies the wireless device of a newly offered communication protocol the wireless device inquires with the user whether to switch to the new protocol.

Thus, a method for determining the mode of operation of a wireless device in a given environment by comparing local environment usage preferences and restrictions with wireless device capabilities and user preferences is disclosed. Although the invention has been described particularly with reference to the figures, it may appear in any number of systems. It is further contemplated that many changes and modifications may be made by one of ordinary skill in the art without departing from the spirit and scope of the disclosed invention.

1. A method, comprising:
establishing a connection between a wireless electronic device and one or more supervisory devices associated with a local area of wireless coverage;
negotiating an associated environment protocol between the wireless device and the one or more local area supervisory devices; and
determining which functions are available for use on the wireless device in the local area based on the outcome of the negotiation.

2. The method of claim 1 wherein the environment protocol further includes one or more priority levels associated with the local coverage area and a priority level associated with each function of the wireless device.

3. The method of claim 2 wherein negotiating an associated environment protocol between the wireless device and the local area supervisory devices further includes:
comparing the one or more priority levels associated with the local area supervisory devices to each wireless device function priority level; and
setting permissions for the operation of each wireless device function based on the results of the comparison.

4. The method of claim 3 wherein setting permissions for the operation of each wireless device function further comprises:
allowing the operation of functions that have a higher priority level than any local area supervisory device priority level; and
disallowing the operation of functions that have a lower priority level than a local area supervisory device priority level.

5. The method of claim 4 wherein determining which functions are available on the wireless device further comprises configuring the wireless device to operate with the settings most preferred by the user that are still allowed by the one or more local area supervisory devices.

6. The method of claim 1 wherein the environment protocol is comprised of a set of preferences associated with the functions of the wireless device and a set of preferences and restrictions associated with the one or more local area supervisory devices.

7. The method of claim 6 wherein negotiating an associated environment protocol between the wireless device and the local area supervisory devices further comprises:
comparing the priority level associated with each local area supervisory device preference and restriction to the priority level associated with each wireless device function; and
setting permissions for the operation of each wireless device function based on the results of the comparison.

8. The method of claim 1 wherein negotiating an associated environment protocol between the wireless device and the one or more local area supervisory devices further comprises:
comparing local area preferences and restrictions associated with each local area supervisory device with capabilities and user preferences of the wireless device; and
setting permissions for the operation of each wireless device function based on the results of the comparison.

9. The method of claim 1 wherein the determination of which functions are available to the wireless device is made by the wireless device.

10. The method of claim 1 wherein the determination of which functions are available to the wireless device is made by one or more of the local area supervisory devices.

11. The method of claim 1 wherein the determination of which functions are available to the wireless device is made by a combination of the wireless device and one or more local area supervisory devices.

12. A machine readable medium having embodied thereon instructions, which when executed by a machine, comprises:
establishing a connection between a wireless electronic device and one or more supervisory devices associated with a local area of wireless coverage;
negotiating an associated environment protocol between the wireless device and the one or more local area supervisory devices; and
determining which functions are available for use on the wireless device in the local area based on the outcome of the negotiation.

13. The machine readable medium of claim 12 wherein the environment protocol further includes one or more priority levels associated with the local coverage area and a priority level associated with each function of the wireless device.

14. The machine readable medium of claim 13 wherein negotiating an associated environment protocol between the wireless device and the local area supervisory devices further includes:
comparing the one or more priority levels associated with the local area supervisory devices to each wireless device function priority level; and
setting permissions for the operation of each wireless device function based on the results of the comparison.

15. The machine readable medium of claim 14 wherein setting permissions for the operation of each wireless device function further comprises:
allowing the operation of functions that have a higher priority level than any local area supervisory device priority level; and
disallowing the operation of functions that have a lower priority level than a local area supervisory device priority level.

16. The machine readable medium of claim 15 wherein determining which functions are available on the wireless device further comprises configuring the wireless device to operate with the settings most preferred by the user that are still allowed by the one or more local area supervisory devices.

17. The machine readable medium of claim 12 wherein the environment protocol is comprised of a set of preferences associated with the functions of the wireless device and a set of preferences and restrictions associated with the one or more local area supervisory devices.

18. The machine readable medium of claim 17 wherein negotiating an associated environment protocol between the wireless device and the local area supervisory devices further comprises:
comparing the priority level associated with each local area supervisory device preference and restriction to the priority level associated with each wireless device function; and
setting permissions for the operation of each wireless device function based on the results of the comparison.

19. A system, comprising:
a bus;
a processor coupled to the bus;
a network interface coupled to the bus; and
memory coupled to the processor, the memory adapted for storing instructions, which upon execution by the processor establish a connection between a wireless electronic device and one or more supervisory devices associated with a local area of wireless coverage, negotiate an associated environment protocol between the wireless device and the one or more local area supervisory devices, and determine which functions are available for use on the wireless device in the local area based on the outcome of the negotiation.

20. The system of claim 19 wherein the environment protocol further includes one or more priority levels associated with the local coverage area and a priority level associated with each function of the wireless device.

21. The system of claim 20 wherein negotiating an associated environment protocol between the wireless device and the local area supervisory devices further includes:
comparing the one or more priority levels associated with the local area supervisory devices to each wireless device function priority level; and
setting permissions for the operation of each wireless device function based on the results of the comparison.

22. The system of claim 21 wherein setting permissions for the operation of each wireless device function further comprises:
allowing the operation of functions that have a higher priority level than any local area supervisory device priority level; and
disallowing the operation of functions that have a lower priority level than a local area supervisory device priority level.

23. The system of claim 22 wherein determining which functions are available on the wireless device further comprises configuring the wireless device to operate with the settings most preferred by the user that are still allowed by the one or more local area supervisory devices.

24. The system of claim 19 wherein the environment protocol is comprised of a set of preferences associated with the functions of the wireless device and a set of preferences and restrictions associated with the one or more local area supervisory devices.

25. The system of claim 24 wherein negotiating an associated environment protocol between the wireless device and the local area supervisory devices further comprises:
comparing the priority level associated with each local area supervisory device preference and restriction to the priority level associated with each wireless device function; and
setting permissions for the operation of each wireless device function based on the results of the comparison.

26. The system of claim 19 wherein negotiating an associated environment protocol between the wireless device and the one or more local area supervisory devices further comprises:
comparing local area preferences and restrictions associated with each local area supervisory device with capabilities and user preferences of the wireless device; and
setting permissions for the operation of each wireless device function based on the results of the comparison.

27. The system of claim 19 wherein the determination of which functions are available to the wireless device is made by the wireless device.

28. The system of claim 19 wherein the determination of which functions are available to the wireless device is made by one or more of the local area supervisory devices.

29. The system of claim 19 wherein the determination of which functions are available to the wireless device is made by a combination of the wireless device and one or more local area supervisory devices.
